(19) United States
(12) Patent Application Publication
(10) Pub. No.: US 2010/0163085 A1
(43) Pub. Date: Jul. 1, 2010

(54) Free Standing Treatment Device For A Dishwasher

(76) Inventors: Jocelin Langford, Brigg (GB); Kuldeep Kanwar, Hull (GB); Steve Walsh, Hull (GB)

Correspondence Address: PARFOMAK, ANDREW N.;NORRIS MCLAUGHLIN & MARCUS PA, 875 THIRD AVE, 8TH FLOOR, NEW YORK, NY, 10022, US

(21) Appl. No.: 12/529,954

(22) PCT Filed: Feb. 26, 2008
(86) PCT No.: PCT/GB08/00632

§ 371 Date: Feb. 8, 2010

(30) Foreign Application Priority Data
Mar. 7, 2007 (GB) 0704379.7

(51) Int. Cl. B08B 3/00; B67D 7/02

(52) U.S. Cl. 134/198; 222/251

(57) ABSTRACT

The invention provides a free standing treatment device for a dishwasher, the device comprising a. housing (I) containing a battery (10), a reservoir (5) of liquid, a transducer (8) arranged to receive power from the battery (10), the transducer (8) being operable to generate a mist of the liquid droplets which are ejected from an outlet in the housing (1). The device allows for the dosing of treatment compositions directly and automatically into the dishwasher.

The present device relates to a free standing treatment device for a dishwasher.

Free standing devices for dishwashers are, as far as we aware, limited to devices which dispense fragrance to mask odours caused by unwashed items in the dishwasher and devices for dispensing dishwasher cleaning chemicals, such as limescale removers during the wash cycle.

According to the present invention, there is provided a free standing treatment device for a dishwasher, the device comprising a housing containing a battery, a reservoir of liquid, a transducer arranged to receive power from the battery, the transducer being operable to generate a mist of the liquid droplets which are ejected from an outlet in the housing.

The device generates a mist of liquid droplets which is dispersed within the dishwasher. This reduces the possibility of dirty items within the dishwasher drying out stopping the dirt becoming encrusted onto the items, thereby improving the effectiveness of the dishwasher cleaning cycle.

It is known in the art for integral devices within the dishwasher to generate a mist liquid to fulfil the same function. This is known, for example, from EP 1 611 831, EP 0 291 713 and JP 2002/249815. However, the present invention provides the possibility for this functionality to be introduced into all dishwashers.

The transducer may be in direct contact with the reservoir, for example, it may float on or be submerged in the reservoir. Alternatively, the device may further comprise a wick arranged to transport liquid from the reservoir to the transducer.

The device can be actuated in a number of ways. There may be a one-off trigger which the user operates when the device is first placed into the dishwasher. Alternatively, there may be a thermal element which senses when a dishwashing cycle is complete and actuates the device subsequent to the completion of the cycle. However, preferably, there is a manually operable switch which the user operates each time they wish the device to be actuated.

Following actuation, the dispensing may take place in a number of ways. Dispensing may simply occur at preset intervals until the liquid or battery is used up. Alternatively, the actuation may trigger only a single dispensing operation until the device is next actuated. However, preferably, the device is arranged to dispense a number of times following actuation to dispense a proportion of the liquid in the reservoir.

The user is able to actuate the device once they begin loading the dishwasher. The device will then dispense at regular intervals a finite number of times to ensure that there is a regular distribution of the mist throughout the dishwasher between actuation and the next expected wash cycle.

The interval between dispensing operations may be predetermined. Alternatively, there may be a user interface in order to vary the interval between dispensing operations. A user who typically uses their dishwasher on a daily basis will be able to set a more frequent interval, while a user who uses the dishwasher only every few days will set a greater interval.

Preferably, a sensor is provided to detect that a wash cycle is under way and prevent operation of the device at this time. Such a sensor may be a thermal sensor or a moisture sensor.

The sensor may also cause a user actuation mechanism to be reset. Alternatively, the mechanism may be arranged to be reset manually by the user or automatically after a predetermined period of time.

The liquid may simply be water. However, preferably, the liquid also contains other agents. These include any of a film former to lock moisture into the dirt (e.g., PVP, alginates, chitosan, polyacrylic acid, hydroxyl celluloses), an ionic liquid to keep the plates wet (e.g., chlorine chloride, urea peroxide or similar), a bleach cleaner system, a surface cleaner with surfactant system, or some combination of the above.

The treatment device may have means to trap water within the dishwasher and direct this to the reservoir for subsequent use in forming the mist. Alternatively, the reservoir may be replaceable as part of a refill. The battery (or batteries) may also be replaceable as part of a refill. In practice, it has been determined that the amount of liquid which can be dispensed by batteries of a practical size means that it is practical to have a replaceable reservoir, rather than replenishing the reservoir from the dishwasher water. However, should battery technology improve, or should it be desirable to provide a rechargeable device, the device would have the capacity to handle a greater volume of liquid before the batteries needed replacing, thereby making the trapping of water from the dishwasher cycle more desirable.

It is currently envisaged that the device will dispense one millilitre of liquid each time the transducer dispenses. It is envisaged that, following actuation, the transducer will dispense four times at intervals of around four hours before it must be actuated again. Current battery technology will allow the dishwasher to do approximately 30 washes which represents 120 dispensing operations of the transducer and a reservoir volume of 120 millilitres.

An example of the device in accordance with the present invention will now be described with reference to the accompanying drawings, in which:

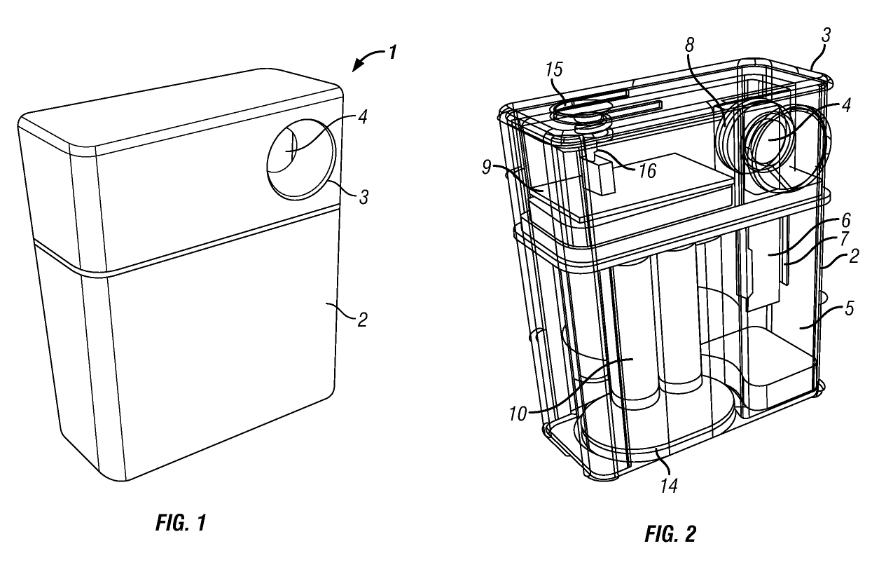

FIG. 1 is a perspective view of the overall device;

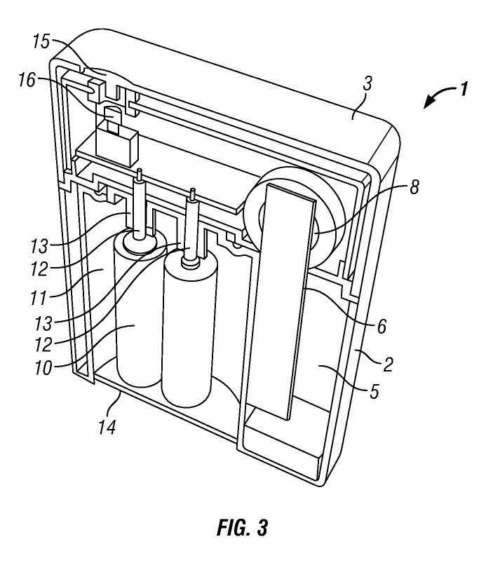

FIG. 2 is a similar view with the external casing shown in outline to enable the internal components to be seen; and

FIG. 3 is a different perspective with the front of the casing removed to show the internal components.

As shown in FIG. 1, the device has a substantially rectangular configuration with a two-part housing 1. The lower housing is a refill housing 2 and the upper housing 3 houses the permanent internal components. The housing 3 has an orifice 4 from which liquid is ejected as described below.

The dimensions of the device are 110 mm×85 mm×38 mm. The dimensions and shape are designed to allow the device to be placed. in one of the trays of a dishwasher without occupying too much space. The dimensions and shape could, of course, differ from those shown. The device may be provided with an attachment mechanism such as a clip to allow the device to be clipped onto the dishwasher tray. Alternatively, the device may have a hook to allow it to hang from the upper tray.

The device comprises a reservoir 5 in which a wick 6 is dipped. The wick is supported on both sides by a wick housing 7 to ensure that it maintains its vertical configuration. The wick leads into the upper housing 3 and terminates at a position immediately behind the opening 4. A piezo-electric transducer 8 is positioned immediately behind the portion of the wick 6 adjacent to the orifice 4.

Operation of the piezo-electric transducer is controlled by a PCB 9 powered by batteries 10.

The batteries 10 are provided in a sealed chamber 11 in the refill housing 2. A pair of electrical contact members 12 project from the upper housing 3 and are sealed with respect to this housing. The refill housing 2 is provided with a pair of bushings 13 which guide the contact members 12 into electrical contact with the batteries 10. The chamber 11 is provided with a cap 14 which is sealed in place. This is not designed to be removable by the user to replace the batteries 10 as the batteries are intended to be replaced together with the entire refill housing 2. Instead, it is provided to allow access to the batteries after use to enable the batteries 10 to be recycled.

Although not shown in the drawings, a partition is provided in the upper housing 3 between the PCB 9 and the transducer 8. This is to ensure that the PCB 9 is maintained in a sealed environment with only the power connections to the transducer passing across the partition.

A button 15 is provided in the top of the upper housing 3. When depressed, this makes contact with a contact member 16 mounted on the PCB to allow the device to be activated. A more sophisticated user interface such as a rotatable knob allowing the frequency of operation to be adjusted could also be provided.

When first buying the device, the user will obtain the complete device as shown in the drawings. For subsequent purchases, they will purchase only the refill. They will then remove the lower refill housing 2 and its associated components by pulling it away from the upper housing, possibly after having released one or more latches. A new refill is then slotted into place. The refill consists of the refill housing 2 with the batteries 10 and reservoir 5. The reservoir will initially be covered by a removable membrane which is removed by the consumer prior to fitting the refill. The removable membrane need only cover the portion of the reservoir which receives the wick 6 and wick housing 7. In fitting the refill in place, the contacts 12 will be brought into contact with the batteries and the wick 6 will enter the reservoir 5. It is also possible for the wick 6 to be part of the refill in which case the wick will be pushed up into place between the transducer 8 and orifice 4.

The user then presses button 15 to activate the device and places the device into the dishwasher.

Intermittently, in accordance with the stored programme on the PCB, the transducer 8 is activated to vibrate ultrasonically to disperse a mist of liquid droplets from the portion of the wick 6 which is in line with the orifice 4. In between operations, the wick 6 will draw further liquid into proximity with the opening 4 for subsequent dispersement.

The device is intended to remain in the dishwasher during the washing cycles of the dishwasher. It is therefore subjected to elevated temperatures and is exposed to significant quantities of circulating water. It should be noted that the chamber 11 for the batteries 10 is significantly larger than the batteries 10. The chamber is filled with insulation (not shown) such as polyurethane which insulates them from the elevated temperatures. The device is sealed other than at the orifice 4 which, as shown, is recessed back from the front of the device. This limits as much as possible the quantity of circulating water which reaches the orifice 4. Any water which does reach the orifice will generally simply wet the wick 4 and actually has a beneficial effect as this water can be dispersed as a mist in the following dispersement cycle. Any additional water will simply seep down the wick and into the reservoir 5 but cannot reach the PCB 9 or the batteries 10.

1. A free standing treatment device for a dishwasher, the device comprising a housing containing a battery, a reservoir of liquid, a transducer arranged to receive power from the battery, the transducer being operable to generate a mist of the liquid droplets which are ejected from an outlet in the housing.

2. A device according to claim 1, wherein the transducer is in direct contact with the reservoir.

3. A device according to claim 1, further comprising a wick arranged to transport liquid from the reservoir to the transducer.

4. A device according to claim 1, further comprising a manually operable switch which the user operates each time they wish the device to be actuated.

5. A device according to claim 1, wherein the device is arranged to dispense a number of times following actuation to dispense a proportion of the liquid in the reservoir.

6. A device according to claim 5, wherein the interval between dispensing operations is preset.

7. A device according to claim 5, further comprising a user interface in order to vary the interval between dispensing operations.

8. A device according to claim 1, further comprising a sensor to detect that a wash cycle is under way and prevent operation of the device at this time.

9. A device according to claim 1, wherein the liquid is water.

10. A device according to claim 9, wherein the water contains cleaning agents and/or a fragrance.

11. A device according to claim 1, further comprising with means to trap water within the dishwasher and direct this to the reservoir for subsequent use in forming the mist.

12. A device according to claim 1, wherein the reservoir is replaceable as part of a refill.

13. A device according to claim 1, wherein the battery is replaceable as part of a refill.

14. A refill for a dispenser according to claim 1, the refill comprising the reservoir of liquid, the battery and an interface for mating with the rest of the device such that the battery is electrically connected to the transducer and the transducer is in fluid communication with the reservoir.

15. A refill according to claim 14, wherein the refill further comprises the wick.

16. A refill according to claim 14, wherein the wick is in the non-refill part of the device.
